(19) United States
(12) Patent Application Publication
(10) Pub. No.: US 2007/0034455 A1
(43) Pub. Date: Feb. 15, 2007

(54) Saftey device for maintenance personnel on a car roof

(76) Inventors: Thomas Coquerelle, Douai (FR); Franck Det, Saint-Martin-Sur-Ocre (FR)

Correspondence Address: Lisa A Bongiovl;Otis Elevator Company, 10 Farm Spring, Famington, CT, 06032, US

(21) Appl. No.: 10/573,900

(22) PCT Filed: Oct. 2, 2003
(86) PCT No.: PCT/IB03/04368

§ 371 Date: Mar. 29, 2006

(51) Int. Cl. B66B 7/00

(52) U.S. Cl. 187/414; 187/364

(57) ABSTRACT

The safety device according to the invention for maintenance personnel in elevators having no machine rooms and flexible tension member, the elevator booth comprising an upper median crosspiece (5) on its roof forming part of its support arcade is characterized in that it comprises, with symmetry with respect to the median traction plane of the booth or to the median plane of the set of flexible tension members (17), at least two rigid rods (9) mounted sliding on the crosspiece (5) on one side and approximately parallel to the latter and able to be moved in an active outgoing position projecting from the crosspiece (5) so as to come opposite and simultaneously in contact with a corresponding stop (23) fixed at an adequate height on the booth guide rail (21), and in an inactive incoming position where they are out of range of said stop (23) corresponding to the normal functioning of the elevator.

The invention concerns a safety device for maintenance personnel in elevators not having any machine room and with flexible tension members and in particular large capacity GeN2 type elevators.

For this large capacity type of elevator, certain operations can not be carried out directly from the booth roof but from a raised platform on the booth roof making it possible to access components located higher up.

Nevertheless, in this configuration, the space remaining between the ceiling of the casing and the maintenance platform when the counterweight is on damper is small, that is in all cases less than one meter according to the standard, and should an incident occur, a brake fuse or a loss of adherence, etc., it may lead to an uncontrolled elevation of the booth lighter than the counterweight and accordingly to a risk of crushing the maintenance operator between the platform and the casing ceiling.

Moreover, there is available a safety rod type device for elevators able to enter into locking in the holes of a fixed plate, this device being fixed laterally to the upper median crosspiece of the booth. This device does not allow the rods to come out in the inspection position as these would encounter a non-selected locking hole in this manoeuvre and in addition the out-of-centre positioning of this device risks provoking a torsion of the booth which is incompatible with a belt drive.

The invention seeks to mitigate these drawbacks and offers a safety device for maintenance personnel in elevators having no machine room and flexible tension members, the elevator booth comprising an upper median crosspiece on its roof forming part of its support arcade, the drive machine being fixed at least to the top of a booth guide rail on the side of the casing of the elevator, said device being characterised in that it comprises, with symmetry with respect to the median traction plane of the booth or to the median plane of the set of flexible tension members, at least two rigid rods mounted sliding on the crosspiece on one side and approximately parallel to the latter and able to be moved in an active outlet position projecting from the crosspiece so as to come opposite and simultaneously in contact with a corresponding stop fixed at a suitable height on the booth guide rail and in an inactive incoming position where they are out of reach of said stop corresponding to the normal functioning of the elevator, the functioning in maintenance mode or inspection of the elevator by a maintenance operator on the booth roof only being allowed at the outlet position of the rods where a safety space for maintenance operator on a working platform on the booth roof is embodied by the fact of the contact of the coming out rods on said guide rail stop.

The flexible tension members may be belts or ropes, and specially flat belts or flat ropes.

Because of this symmetrical mounting of the booth traction plane of the rods and their stop, there is no torsion of the booth inside this plane on safely stopping the booth and thus no effect on a possible consecutive shifting of the flexible tension members on their pulley is generated. This shifting specially for flat belts could in fact take place for a booth torsion angle of about 0.5°.

In addition, the functioning of the elevator in inspection or maintenance mode implies the activation of the safety device for avoiding crushing persons and cannot exist without this activation, which is not the case with the multi-hole plate safety device of the known prior art.

The at least two said rigid rods are mounted integral with each other on a given trolley mounted sliding under the upper crosspiece at a short distance from the latter and parallel to its median longitudinal plane. Thus, the device occupies a small amount of space under the crosspiece and does not take up much space on the roof of the booth which remains available for maintenance operators.

Said trolley is advantageously equipped with a control lever which allows the manoeuvre of rods in either an outgoing or incoming position which can be locked by a dog positive clutch device or similar device.

Said trolley can be mounted returned to an outgoing position by a suitable spring element which keeps the rods in the outgoing position as soon as they are freed from the incoming position, which strengthens the safety condition for placing the elevator in a maintenance or inspection position by preventing the rods from occupying an accidental intermediate position.

The mode of functioning of the elevator in the maintenance or inspection position is advantageously obtained by an electric contact triggered onto the outgoing position of the rods and closing the operating control circuit of the elevator, placed in series with a first switch for controlling authorisation of functioning in inspection or maintenance mode, and possibly a second elevator maximum safety travel contact controlling stoppage of the elevator when the booth is a short distance from the stopping position, thus preventing it from possibly stopping. The circuit is therefore closed by the first authorisation contact, closed by the safety contact of functioning activated by the coming out of the rods, and closed by the second maximum travel contact of the booth on maintenance signifying that the booth is found in a maximum upper position close to the stop position. Any opening of one of these contacts stops the elevator.

Said corresponding stop of the rods can be a metal flat bar fixed by bolts onto the rear wall of the guide rail and cut with two symmetrically square folds with respect to the median longitudinal plane of the rail, each of these folds being on the vertical stroke of a rod for their simultaneous stopping were the booth to accidentally exceed the travel height allowed in the maintenance or inspection mode. This stop can also be an angle steel fixed by a rigidly tightened clip to the rail with possibly a shock absorber protecting against a metal/metal impact.

This stop is placed on the booth guide rail at a height allowing the maintenance operator on his working platform a minimum safety height of more than 180 cm.

In addition, it is to be noted that for this GeN2 elevator configuration, the machine rests on the top of to counter weight guide rails and on the top of the corresponding side booth guide rail to which the stop is secured, this rail being further loaded by the booth and the counterweight and resting at the casing bottom. The rail is unable to slide on its fixing fishplates and as a result the stop stays fully fixed in position.

The invention is illustrated hereafter with the aid of an embodiment example and with reference to the accompanying drawings on which:

FIG. 1 is a diagrammatic elevation view of a safety device according to the invention on a GeN2 elevator,

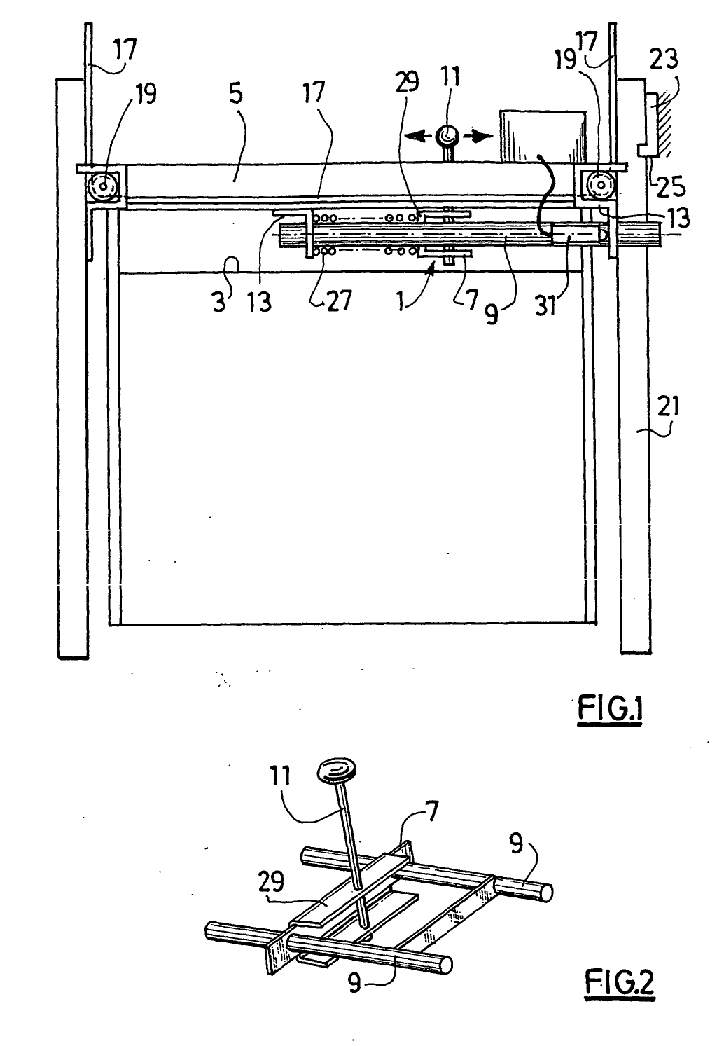

FIG. 2 is a perspective view of the support trolley of the rigid rods with its control lever,

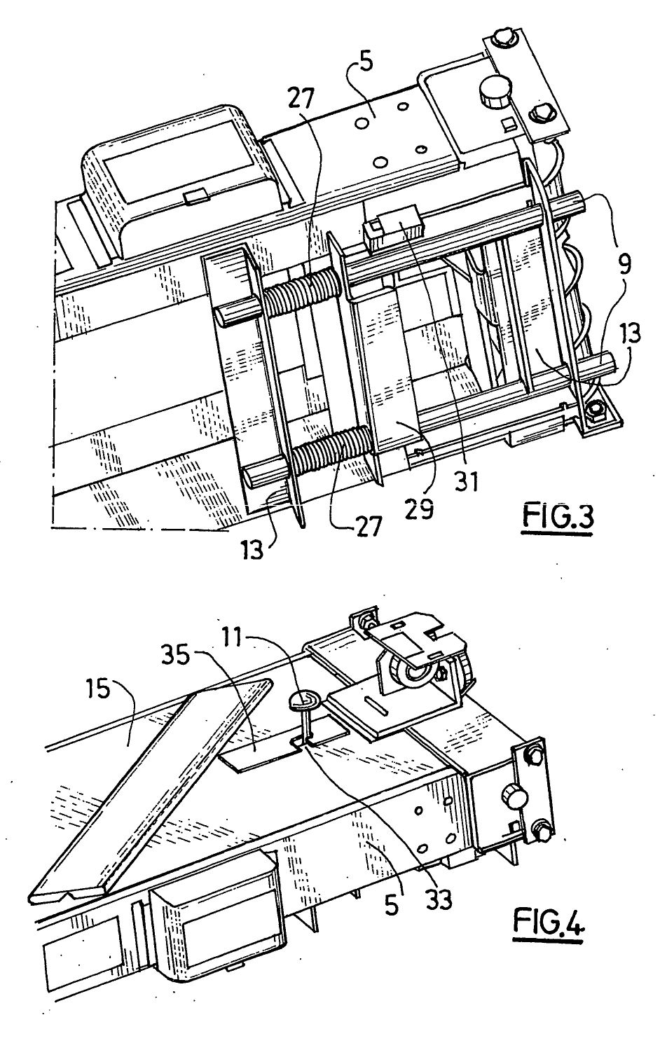

FIG. 3 is a perspective view of the device under the booth upper crosspiece,

FIG. 4 is a top view of the device showing the control lever with the rods in a incoming locked position,

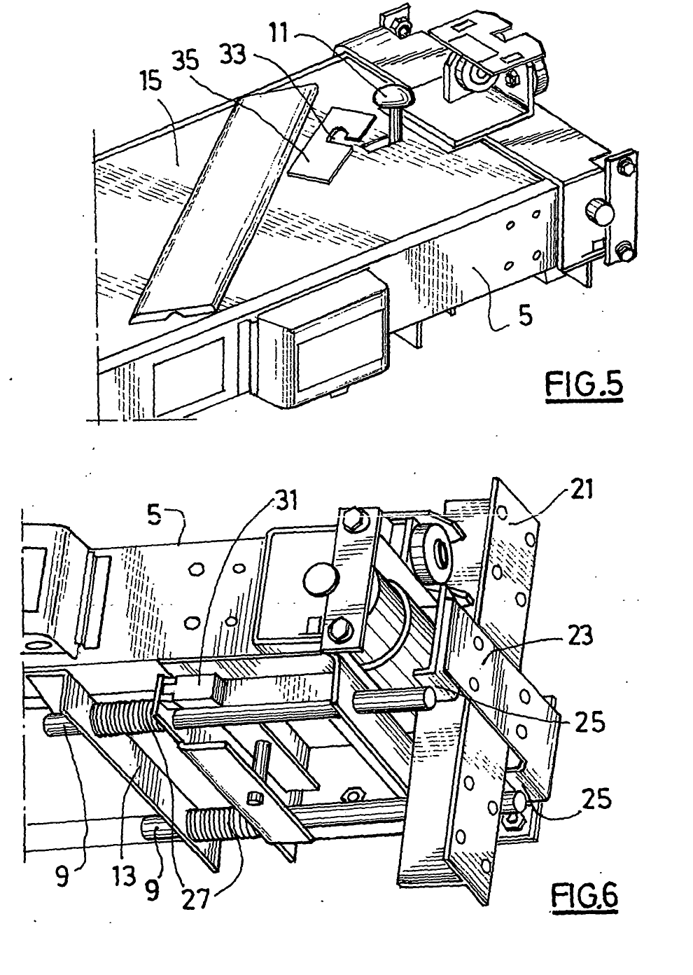

FIG. 5 is a view similar to FIG. 4 showing the lever in the outgoing rods position, and

FIG. 6 is a perspective view showing the device in the active stop position.

A safety device 1 according to the invention is shown on FIG. 1. Said device is mounted close to the roof 3 of a GeN2 type elevator booth without any machine room and with flat traction belts, and is placed under the booth arcade upper crosspiece 5. It is made up of a trolley 7 (FIG. 2) including two identical rigid rods 9 connected parallel to each other and an approximately central vertical control lever 11.

This trolley 7 slides via its rods 9 on two angle steel elements 13 integral with the upper crosspiece. The rods slide with slight play into complementary holes of the angle steels, the angles steels being placed opposite each other approximately at the extremity of the rods.

The crosspiece 5 receives the control lever 11 via its central opening protected by a housing plate 15, and the handle of said lever exceeds the upper level by a suitable opening.

The crosspiece 5 further receives the flat traction belts 17 of the booth, for example, four placed parallel on a given horizontal plane and concerning its width.

The median traction plane of the booth corresponds to the median plane of the two extremity pulleys 19 of the crosspiece receiving in return the traction belts.

The rigid rods 9 of the trolley are mounted symmetrically with respect to this traction plane and thus are parallel and at an equal distance from the traction plane which is also the median longitudinal plane of the upper crosspiece.

The rods slide on angle steels 13 under the control of the control lever 11 and are able to come out projecting from the crosspiece 5 so as to stop on both sides of the guide rail 21, at an equal distance from the latter and simultaneously, on a stop element 23 fixed to the rail 21. This stop element 23 is a simple plate comprising tow lateral folds 25 orientated towards the inside at 90° and placed at an equal distance from the rail opposite the outgoing rods 9.

The rods 9 can also slide towards the inside up to a locked incoming position under the crosspiece 5 where they are out of reach of the stop element 23 in the elevator normal functioning mode.

They each further receive a helical spring 27 (FIG. 3) threaded on their rear portion and in support on the rear angle steel 13 and on a median linking bar 29 of the rods. The springs 27 are compressed and bring the rods 9 back into their outgoing position.

An electric contactor 31, at an appropriate position on the upper crosspiece gives information on the outgoing position of the rods when it is applied on the linking bar 29.

This connector 31 is placed on the electric circuit (not shown) in the elevator maintenance functioning mode, in series with the control switch (not shown) in maintenance mode and as previously indicated with another maximum travel contactor of the booth in maintenance mode (not shown) placed close, such as between 20 and 50 mm, to the stop 23 on the rail. This contactor opens the circuit at the arrival of the booth to its contact so as to halt functioning and avoid the mechanical impact of the rods when they stop on the stop of the rail.

FIG. 4 is a top view of the crosspiece showing the control lever 11 engaged locked in the incoming rods position. The lever is kept in position by the notch slot 33 of an insert 35 which can be rotated on the upper housing 15, whereas the lever 11 is simultaneously pulled so as to be freed in the brought back position of the outgoing rods (FIG. 5) where the device is put in the active safety position in maintenance mode ready to place in stop contact the rods 9 with the rail stop 23 if required (FIG. 6).

Functioning is simple.

The operator responsible for maintenance of the elevator presses the maintenance control switch, frees the lever 11 of the safety device by rotating the incoming locking position 35 and can then use the elevator in maintenance mode for carrying out his work. He no longer needs to do anything else. The maximum travel contactor shall stop the elevator on approach of the stop 23 and if an incident should occur concerning the brake or adherence, the booth shall stop via the stopping of the rods 9 on the rail stop 23 at a sufficient distance from the casing ceiling, namely 180 cm, so that the operator is completely protected.

It will be noted as an alternative embodiment, that the device according to the insertion can be mounted in elevators having the drive machine resting only on the top of a booth guide rail with the stop fixed on the same.

1. Safety device for elevators having no machine room and flexible tension member, the device comprising:
an upper median crosspiece forming part of a support arcade; and
at least two rigid rods mounted sliding on the crosspiece and arranged symmetrically with respect to a median traction plane,
wherein the at least two rigid rods are adapted to move in an active outgoing position projecting from the crosspiece so as to come opposite and simultaneously in contact with a corresponding stop fixed at an adequate height on a guide rail, and the at least two rigid rods are adapted to move in an inactive incoming position so as to be out of range of the stop, the inactive incoming position corresponding to a normal operating mode of the elevator, active outgoing position corresponding to a maintenance or inspection mode of the elevator.

2. Safety device according to claim 1, wherein the at least two rigid rods are mounted sliding in relation to each other on a trolley which is mounted sliding under the upper crosspiece.

3. Safety device according to claim 2, wherein the trolley is equipped with a control lever which allows the maneuvering of rods in either an outgoing or incoming position, the control lever can be locked by a dog clutch device or similar device.

4. Safety device according to claim 2, wherein each of the rods receives a spring element that is arranged to keep the rods in the outgoing position once they have been freed from the incoming position.

5. Safety device according to claim 1, further comprising a first electric contact placed in series with a first control switch that authorizes functioning of the inspection or maintenance mode, the electric contact is configured to be triggered when the at least two rigid rods are in the outgoing position, the electric contact closes the elevator functioning control circuit.

6. Safety device according to claim 1, wherein the stop is a metal flat bar secured by bolts to a rear wall of the guide rail and cut with two symmetrically square folds with respect to a longitudinal plane of the rail, these folds each being arranged to receive the rod to stop the rods simultaneously.

7. Safety device according to claim 1, wherein the stop is an angle steel fixed by a clip rigidly tightened to the rail.

8. Safety device according to claim 1, wherein the stop comprises packing material protecting any metal/metal impact.

9. Safety device according to claim 1, wherein the stop is placed on the car guide rail at a height to provide a minimum safety height of more than 180 cm.

10. Safety device according to claim 1, wherein the flexible tension members are ropes.

11. Safety device according to claim 1, wherein the flexible tension members are belts.

12. Safety device according to claim 5, further comprising a second electric contact that is configured to stop the elevator car and arranged at a position so as to stop the elevator car before the at least two rigid rods impact the stop.
